(19) United States
(12) Patent Application Publication
(10) Pub. No.: US 2026/0255241 A1
(43) Pub. Date: Aug. 27, 2026

(54) BLOCK ACKNOWLEDGEMENT CONTEXT TRANSFER AND RENEGOTIATION DURING ROAMING

(71) Applicant: Cisco Technology, Inc., San Jose, CA (US)

(72) Inventors: Binita GUPTA, San Diego, CA (US); Brian D. HART, Sunnyvale, CA (US)

(21) Appl. No.: 19/549,562

(22) Filed: Feb. 25, 2026

Related U.S. Application Data
(60) Provisional application No. 63/763,072, filed on Feb. 25, 2025.

(51) Int. Cl. H04W 36/08; H04L 1/1607; H04L 5/00

(52) U.S. Cl. CPC H04W 36/08; H04L 1/1614; H04L 5/0053

(57) ABSTRACT

Described herein is a wireless network that allows non-AP MLDs and AP MLDs to adjust, negotiate, or renegotiate BA agreements during roaming. A first AP MLD includes one or more memories and one or more processors communicatively coupled to the one or more memories. The one or more processors, individually or collectively, perform an operation that includes receiving a message indicating that (i) a first BA agreement with a non-AP MLD should be maintained when the non-AP MLD roams from the first AP MLD to a second AP MLD and (ii) a second BA agreement with the non-AP MLD should be changed when the non-AP MLD roams from the first AP MLD to the second AP MLD, and based on the message, communicating the first BA agreement to the second AP MLD and refraining from communicating the second BA agreement to the second AP MLD.

### CROSS-REFERENCE TO RELATED APPLICATIONS

This application claims benefit of co-pending United States provisional patent application Serial No. 63/763,072 filed February 25, 2025. The aforementioned related patent applications are herein incorporated by reference in their entirety

### TECHNICAL FIELD

Embodiments presented in this disclosure generally relate to wireless networks. More specifically, embodiments disclosed herein relate to transferring and renegotiating block acknowledgement agreements during roaming in a wireless network.

### BACKGROUND

Wireless networks may allow non-access point multi-link devices (non-AP MLDs) (which may also be referred to as devices or client devices) and access point multi-link devices (AP MLDs) (which may also be referred to as access points) to send multiple frames (or a burst of frames) and then to acknowledge those frames together using a block acknowledgement (BA or Block Ack). In this manner, the non-AP MLDs and AP MLDs avoid the overhead of acknowledging each frame. To implement BAs, the non-AP MLDs and AP MLDs may enter into BA agreements that indicate the amount of resources the non-AP MLDs and AP MLDs use to handle BAs. For example, the BA agreements may indicate the number or size of buffers (or buffer size) used by the non-AP MLDs or AP MLDs to hold received frames until those frames are acknowledged. As another example, the BA agreements may indicate a timeout used by the non-AP MLDs or AP MLDs to indicate a duration of time that the non-AP MLDs and AP MLDs wait for acknowledgements.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example network controller, access point, or device of the system of FIG. 1A.

FIG. 2A illustrates an example operation performed by the system of FIG. 1A.

FIG. 2B illustrates an example message in the system of FIG. 1A.

FIG. 2C illustrates an example message in the system of FIG. 1A.

FIG. 3A illustrates an example operation performed by the system of FIG. 1A.

FIG. 3B illustrates an example message in the system of FIG. 1A.

FIG. 4A illustrates an example operation performed by the system of FIG. 1A.

FIG. 4B illustrates an example message in the system of FIG. 1A.

FIG. 4C illustrates an example message in the system of FIG. 1A.

FIG. 4D illustrates an example message in the system of FIG. 1A.

FIG. 5A illustrates an example operation performed by the system of FIG. 1A.

FIG. 5B illustrates an example message in the system of FIG. 1A.

FIG. 6 is a flowchart of an example method performed by the system of FIG. 1A.

FIG. 7 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

The present disclosure describes a wireless network that allows non-AP MLDs and AP MLDs to adjust, negotiate, or renegotiate BA agreements during roaming. According to an embodiment, a first AP MLD includes one or more memories and one or more processors communicatively coupled to the one or more memories. The one or more processors, individually or collectively, perform an operation that includes receiving a message indicating that (i) a first BA agreement with a non-AP MLD should be maintained when the non-AP MLD roams from the first AP MLD to a second AP MLD and (ii) a second BA agreement with the non-AP MLD should be changed when the non-AP MLD roams from the first AP MLD to the second AP MLD, and based on the message, communicating the first BA agreement to the second AP MLD and refraining from communicating the second BA agreement to the second AP MLD.

According to another embodiment, a first AP MLD includes one or more memories and one or more processors communicatively coupled to the one or more memories. The one or more processors, individually or collectively, perform an operation that includes determining that a BA agreement with a non-AP MLD should be changed when the non-AP MLD roams from the first AP MLD to a second AP MLD, determining a change to the BA agreement, and communicating the change to the second AP MLD.

According to another embodiment, an apparatus includes one or more memories and one or more processors communicatively coupled to the one or more memories. The one or more processors, individually or collectively, perform an operation that includes determining that a BA agreement with a serving AP MLD should be changed when roaming from the serving AP MLD to a target AP MLD, determining a change to the BA agreement, and renegotiating or negotiating the BA agreement with the target AP MLD prior to roaming to the target AP MLD.

### EXAMPLE EMBODIMENTS

Wireless networks may allow non-access point multi-link devices (non-AP MLDs) (which may also be referred to as devices or client devices) and access point multi-link devices (AP MLDs) (which may also be referred to as access points) to send multiple frames (or a burst of frames) and then to acknowledge those frames together using a block acknowledgement (BA or Block Ack). In some networks, when a non-AP MLD requests to roam from a first AP MLD (which may also be referred to as a serving AP MLD) to a second AP MLD (which may also be referred to as a target AP MLD), the first AP MLD may transfer, to the second AP MLD, all the BA agreements between the non-AP MLD and the first AP MLD. In this manner, the non-AP MLD and the second AP MLD may continue to follow those BA agreements after the roam. In some instances, however, the second AP MLD may have less resources available than the first AP MLD. For example, the second AP MLD may use or support a smaller buffer size than the first AP MLD. As a result, the second AP MLD may not be able to support the BA agreements.

The present disclosure describes a wireless network that allows non-AP MLDs and AP MLDs to adjust, negotiate, or renegotiate BA agreements during roaming. In a first example, when a non-AP MLD determines that a BA agreement between the non-AP MLD and a serving AP MLD should be adjusted or renegotiated before the non-AP MLD roams to a target AP MLD, the non-AP MLD may request that the serving AP MLD refrain from transmitting the BA agreement to the target AP MLD. As a result, the serving AP MLD may not transfer the BA agreement to the target AP MLD, which signals that the BA agreement should be adjusted or renegotiated.

In a second example, when the non-AP MLD requests to roam from the serving AP MLD to the target AP MLD, the non-AP MLD or the serving AP MLD may determine whether the target AP MLD can support a BA agreement between the serving AP MLD and the non-AP MLD. If the target AP MLD cannot support the BA agreement (e.g., due to smaller buffer size than the serving access point), then the serving AP MLD may update parameters in the BA agreement so that the target AP MLD can support the BA agreement. The serving AP MLD may then transfer the updated BA agreement to the target AP MLD and the non-AP MLD so that the target AP MLD and the non-AP MLD may implement the updated BA agreement when the non-AP MLD roams to the target AP MLD. In one embodiment, the target AP MLD may update the parameters in the BA agreement, instead of the serving AP MLD, and the updated BA parameters are provided to the client. Additionally or alternatively, if the target AP MLD cannot support the BA agreement between the serving AP MLD and the non-AP MLD, the non-AP MLD may renegotiate the BA agreement with the target AP MLD through the serving AP MLD.

In some embodiments, the wireless network provides several technical advantages. For example, the wireless network allows a non-AP MLD and a target AP MLD to renegotiate a BA agreement during the roaming process. As another example, the wireless network allows the non-AP MLD and the target AP MLD to use BAs according to a BA agreement after the non-AP MLD roams to the target AP MLD.

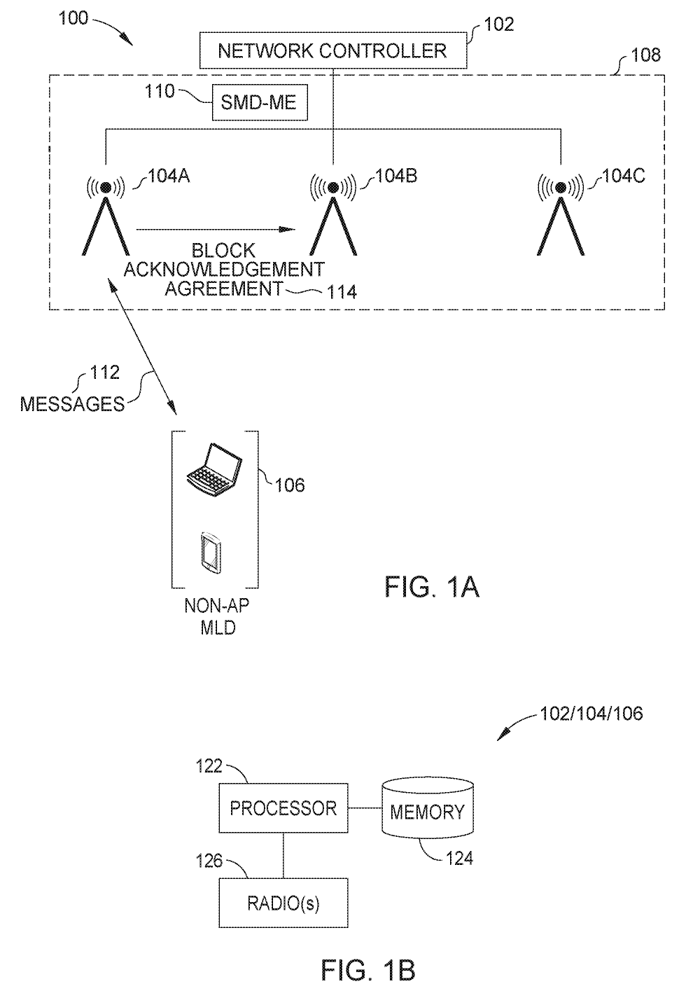

FIG. 1A illustrates an example system 100. As seen in FIG. 1A, the system 100 includes a network controller 102, AP MLDs 104 (e.g., AP MLDs 104A, 104B, and 104C) and one or more non-AP MLDs 106. Generally, the system 100 allows the AP MLDs 104 and the non-AP MLD 106 to adjust or renegotiate BA agreements when the non-AP MLD 106 roams between AP MLDs 104. The AP MLDs 104 may be part of a seamless mobility domain (SMD) 108 and the non-AP MLD is associated with an SMD management entity (SMD-ME) 110 of the SMD.

The network controller 102 facilitates or manages the communication in the system 100. As an example, the network controller 102 may manage the connections between the AP MLDs 104 and the non-AP MLD 106. As another example, the network controller 102 may manage the connections and traffic between the AP MLDs 104.

An AP MLD 104 may be a network device that facilitates wireless communication (e.g., Wi-Fi communication) in the system 100. The non-AP MLD 106 connects to the AP MLD 104, and the AP MLD 104 may facilitate communication to and from the non-AP MLD 106. For example, the AP MLD 104 may receive messages from the non-AP MLD 106 and direct those messages towards their destination. As another example, the AP MLD 104 may receive messages intended for the non-AP MLD 106 and direct those messages to the non-AP MLD 106. The AP MLD 104 may also exchange messages with the network controller 102 or with other AP MLDs 104. Multiple AP MLDs 104 may be implemented in the same physical access point.

A non-AP MLD 106 may be any suitable device for communicating with components of the system 100. As an example and not by way of limitation, the non-AP MLD 106 may be a computer, a laptop, a wireless or cellular telephone, an electronic notebook, a personal digital assistant, a tablet, or any other device capable of receiving, processing, storing, or communicating information with other components of the system 100. The non-AP MLD 106 may be a wearable device such as a virtual reality or augmented reality headset, a smart watch, or smart glasses. The non-AP MLD 106 may also include a user interface, such as a display, a microphone, keypad, or other appropriate terminal equipment. The non-AP MLD 106 may include a hardware processor, memory, or circuitry configured to perform any of the functions or actions of the non-AP MLD 106 described herein. For example, a software application designed using software code may be stored in the memory and executed by the processor to perform the functions of the non-AP MLD 106. Multiple non-AP MLDs 106 may be implemented in the same physical device.

An AP MLD 104 and the non-AP MLD 106 may implement or use BAs to reduce overhead in the system 100. For example, the AP MLD 104 and the non-AP MLD 106 may receive multiple messages or frames and then send one message to acknowledge the multiple messages or frames (as opposed to sending one acknowledgement per received message or frame). The AP MLD 104 and the non-AP MLD 106 may store the received messages or frames or indications of the messages or frames in one or more buffers prior to acknowledging the messages or frames. Certain aspects of using BAs are governed or specified by a BA agreement between the AP MLD 104 and the non-AP MLD 106. For example, the BA agreement may specify a buffer size (e.g., total size of the buffers or total number of buffers) used by the AP MLD 104 or the non-AP MLD 106 to store or hold unacknowledged messages, frames, or media access control (MAC) protocol data units (MPDUs). As another example, the BA agreement may specify a BA timeout value used by the AP MLD 104 and the non-AP MLD 106 to invalidate or tear down an inactive BA agreement (e.g., the BA agreement is invalidated or torn down if no frames or MPDUs are exchanged using that BA agreement for the BA timeout value). The BA agreements may be setup separately for downlink (DL) and uplink (UL) and setting up a BA agreement is usually initiated by the transmitter. A DL BA agreement setup may be initiated by the AP MLD (e.g. by sending an add BA (ADDBA) request) and is setup based on BA agreement parameters (e.g. buffer size and BA timeout value) signaled by the non-AP MLD in a response frame for BA agreements setup (e.g., in the ADDBA response). An UL BA agreement setup is initiated by the non-AP MLD and is setup based on BA parameters (e.g. buffer size and BA timeout value) signaled by an AP MLD in a response frame for BA agreements setup (e.g., in the ADDBA response).

Additionally, the AP MLD 104A and the non-AP MLD 106 may have established multiple BA agreements (e.g., different BA agreements for different traffic identifiers (TIDs)).

The non-AP MLD 106 may roam between AP MLDs 104 in the system 100. For example, the non-AP MLD 106 may initially be connected through the AP MLD 104A. If the non-AP MLD 106 moves further from the AP MLD 104A and closer to the AP MLD 104B, the network controller 102, AP MLD 104A, or non-AP MLD 106 may determine that the non-AP MLD 106 should roam from the AP MLD 104A to the AP MLD 104B for an improved connection. The non-AP MLD 106 may then communicate a roaming request to the AP MLD 104A, and the AP MLD 104A may communicate with the AP MLD 104B to prepare for the roam. When roaming preparation is complete, the non-AP MLD 106 may execute the roam from the AP MLD 104A to the AP MLD 104B, where the AP MLD 104A and the AP MLD 104B are in the same SMD 108.

In some instances, however, the AP MLD 104B may not support the one or more of the BA agreements established between the AP MLD 104A and the non-AP MLD 106. For example, the AP MLD 104B may support a smaller buffer size (or possibly use a different timeout than the AP MLD 104A). As a result, the BA agreement cannot simply be transferred from the AP MLD 104A to the AP MLD 104B to be implemented.

Generally, the system 100 implements certain processes for adjusting or renegotiating the block acknowledgement agreement during roaming. The non-AP MLD 106 may communicate a message 112 (e.g., a roaming request or a roaming preparation request) to the AP MLD 104A to request to roam from the AP MLD 104A (the current or serving AP MLD) to the AP MLD 104B (the target AP MLD). In one process, the AP MLD 104A may determine that the AP MLD 104B can support or honor one or more BA agreements between the AP MLD 104A and the non-AP MLD 106. In response, the AP MLD 104A may communicate the one or more BA agreements 114 to the AP MLD 104B. The AP MLD 104A may also communicate a message 112 (e.g., a roaming response or a roaming preparation response) to the non-AP MLD 106 that may indicate the BA agreements 114, which the non-AP MLD 106 has accepted. The AP MLD 104B may then support the BA agreements 114 when the non-AP MLD 106 roams to the AP MLD 104B. In one embodiment, if the one or more of the BA agreements 114 transferred to the target AP MLD 104B has not been adjusted or changed, then the message 112 sent to the non-AP MLD 106 may not include those unchanged BA agreements (because the non-AP MLD 106 already has parameters for those BA agreements).

In another process, the AP MLD 104A may determine that the AP MLD 104B cannot support or honor one or more of the BA agreements 114 between the AP MLD 104A and the non-AP MLD 106. In response, the AP MLD 104A may adjust the parameters (e.g., buffer size, timeout, etc.) of the BA agreements 114 so that the AP MLD 104B can support or honor the BA agreements 114. The AP MLD 104A may then communicate the adjusted BA agreements 114 to the AP MLD 104B. The adjusted BA agreements are provided to the non-AP MLD 106 as part of the message 112. The AP MLD 104B may then support the BA agreement 114 when the non-AP MLD 106 roams to the AP MLD 104B.

In another process, the non-AP MLD 106 may determine that the AP MLD 104B cannot support or honor the block acknowledgment agreement 114 between the AP MLD 104A and the non-AP MLD 106. In response, the non-AP MLD 106 may indicate in a message 112 that the AP MLD 104A should not communicate the BA agreement 114 to the AP MLD 104B. In response, the AP MLD 104A may refrain from communicating the BA agreement 114 to the AP MLD 104B. In this case, the non-AP MLD 106 and the AP MLD 104B may renegotiate the BA agreement 114 as part of the roaming preparation procedure. The non-AP MLD 106 may include in the message 112 (e.g., in a roaming preparation request) updated parameters for the BA agreement 114, and the AP MLD 104A may provide the updated parameters to the AP MLD 104B. The AP MLD 104B may signal to the AP MLD 104A which updated parameters are accepted, and the AP MLD 104A may indicate (e.g., in the message 112, such as a roaming preparation response) to the non-AP MLD 106 the updated parameters that are accepted. The non-AP MLD 106 may then roam to the AP MLD 104B with a supported BA agreement in place.

In some embodiments, the non-AP MLD 106 may also signal delete BA signaling for some DL BA agreements if the non-AP MLD 106 determines that those DL BA agreements should be renegotiated with the AP MLD 104B (e.g., due to different buffer size). In these instances, the non-AP MLD 106 may request not to transfer or communicate those DL BA agreements to the AP MLD 104B.

FIG. 1B illustrates an example network controller 102, AP MLD 104, or non-AP MLD 106 of the system 100 of FIG. 1A. As seen in FIG. 1B, the network controller 102, AP MLD 104, or non-AP MLD 106 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), or state machines, that communicatively couples to the memory 124 and controls the operation of the network controller 102, AP MLD 104, or non-AP MLD 106. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the network controller 102, AP MLD 104, or non-AP MLD 106 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the network controller 102, AP MLD 104, or non-AP MLD 106 may use one or more of the radios 126 for Wi-Fi communications. The network controller 102, AP MLD 104, or non-AP MLD 106 may use one or more of the radios 126 to transmit messages and one or more of the radios 126 to receive messages. The network controller 102, AP MLD 104, or non-AP MLD 106 may include any number of radios 126 to communicate using any number of communication technologies.

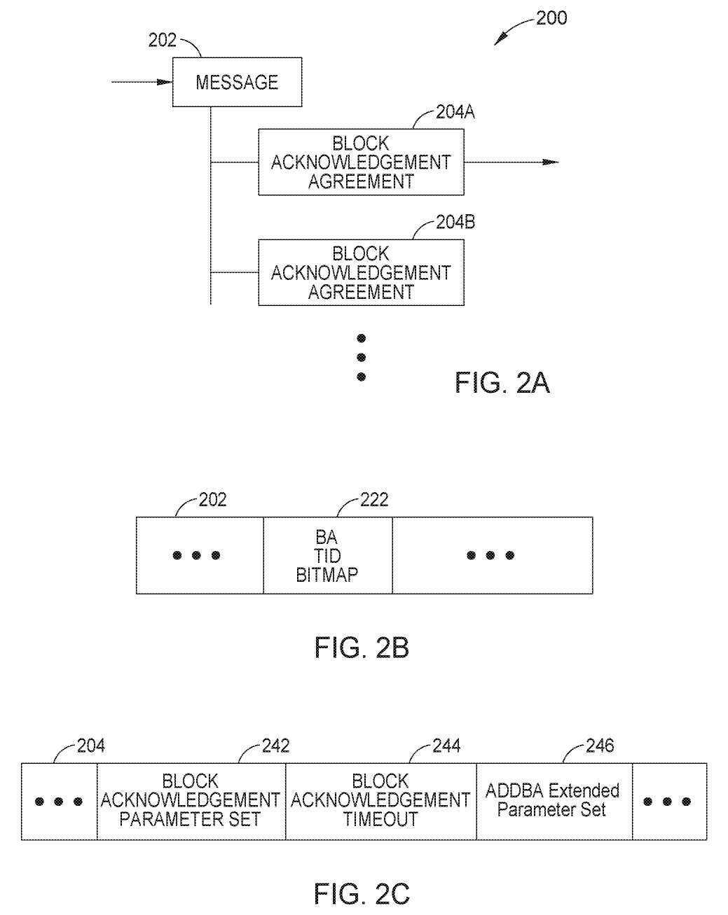

FIG. 2A illustrates an example operation 200 performed by the system 100 of FIG. 1A. Generally, a current or serving AP MLD (e.g., the AP MLD 104A shown in FIG. 1A) may perform the operation 200. By performing the operation 200, the serving AP MLD performs a context transfer during roaming.

The serving AP MLD begins by receiving a message 202 from a non-AP MLD. The message 202 may be a roaming request indicating that the non-AP MLD is roaming from the serving AP MLD to a target AP MLD. In some instances, the message 202 may also indicate one or more BA agreements to preserve and one or more BA agreements to renegotiate/negotiate as part of the roam (e.g., because the target AP MLD cannot support or honor some of the BA agreements). In response, the serving AP MLD may transfer the preserved BA agreements to the target AP MLD and refrain from transferring the other BA agreements to the target AP MLD.

In the example of FIG. 2A, the serving AP MLD has implemented a BA agreement 204A and a BA agreement 204B with the non-AP MLD. The message 202 may indicate that the BA agreement 204A should be preserved or maintained during the roam and that the BA agreement 204B should be changed during the roam. In response, the serving AP MLD may communicate or transfer the BA agreement 204A to the target AP MLD, which signals to the target AP MLD that the BA agreement 204A should be maintained or preserved during the roam. The serving AP MLD may also refrain from communicating or transferring the BA agreement 204B to the target AP MLD, which signals that the BA agreement 204B should be changed during the roam.

In some instances, all BA agreements setup between the non-AP MLD and the serving AP MLD are transferred to the target AP MLD. For example, both the BA agreements 204A and 204B may be transferred to the target AP MLD. In this case, all the BA agreements are transferred unless the non-AP MLD indicates to renegotiate/negotiate some of the BA agreements in the roaming request frame (e.g., signal to renegotiate/negotiate BA agreements for specific TIDs). In this case, already setup BA agreements for TIDs for which BA agreements are indicated for renegotiation/negotiation are not transferred to the target AP MLD.

FIG. 2B illustrates an example message 202 in the system 100 of FIG. 1A. The message 202 (e.g., a roaming request) may be communicated by the non-AP MLD to the serving AP MLD. As seen in FIG. 2B, the message 202 includes a BA traffic identifier (TID) bitmap 222. The BA TID bitmap 222 may include bits for different TIDs. Each bit may indicate whether BA agreements for a TID should be transferred or communicated to the target AP MLD. For example, when a bit is set to 1, the bit may indicate that the BA agreements (e.g., both uplink and downlink BA agreements) for the corresponding TID should not be transferred or communicated to the target AP MLD. In one case, the BA TID bitmap 222 may be indicated separately for UL and DL BA agreements using two separate fields – such as a DL BA TID bitmap and an UL BA TID bitmap. In response, the serving AP MLD may refrain from transferring or communicating the indicated BA agreements (UL and/or DL BA agreements) for the indicated TIDs to the target AP MLD. When a bit is set to 0, the bit may indicate that the BA agreements for a TID should be transferred or communicated to the target AP MLD (or the reverse encoding could be used). In response, the AP MLD may transfer or communicate the BA agreements for the TID to the target AP MLD.

Additionally or alternatively, if the non-AP MLD requests to renegotiate BA agreements for certain TIDs as part of roaming request, then the serving AP MLD may not transfer BA agreements for those TIDs to the target AP MLD.

FIG. 2C illustrates an example message 204 in the system 100 of FIG. 1A. The message 204 may be used to communicate BA agreements (e.g., for a TID) from the current or serving AP MLD to the target AP MLD. For example, the serving AP MLD may communicate the message 204 to the target AP MLD to transfer or communicate BA agreements to the target AP MLD. The message 204 may include information about a BA agreement. In the example of FIG. 2C, the message 204 may include one or more of a BA parameter set 242 for the BA agreement, a BA timeout 244 for the BA agreement, and an ADDBA extended parameter set 246 for the BA agreement. The BA parameter set 242 may include parameters such as buffer size. The BA timeout 244 may indicate a timeout for invalidating or tearing down the BA agreement. The ADDBA extended parameter set 246 may provide extended BA parameters.

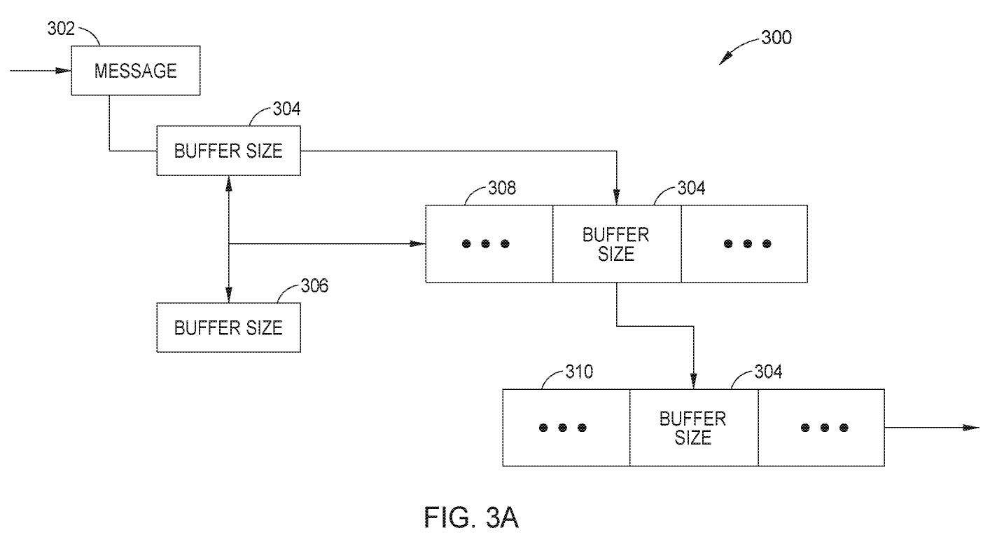

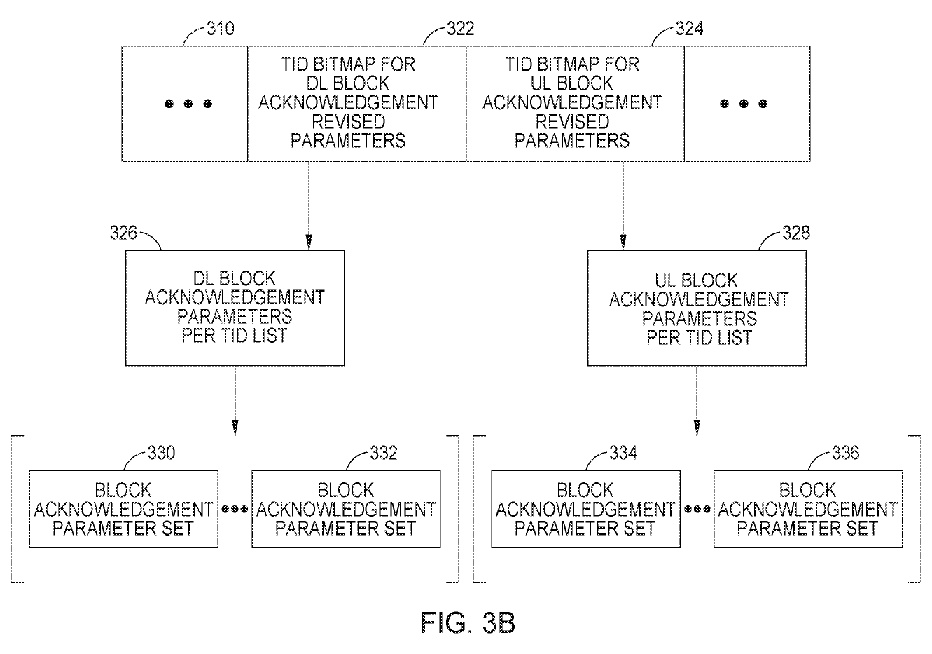

FIG. 3A illustrates an example operation 300 performed by the system 100 of FIG. 1A. Generally, a current or serving AP MLD (e.g., the AP MLD 104A shown in FIG. 1A) performs the operation 300. By performing the operation 300, the serving AP MLD may adjust a block acknowledgement agreement.

The serving AP MLD begins by receiving, from a target AP MLD, a message 302 (e.g., a neighbor report from the target AP MLD, including neighbor info) that indicates a buffer size 304 implemented or used by the target AP MLD. The buffer size 304 supported by a target AP MLD can be received as part of neighbor report information for that target AP MLD (e.g., in a neighbor report element as part of a subelement added to the optional subelements field). For example, the optional subelements field can include the BA parameter set field or buffer size field in a new subelement or an existing subelement. In one embodiment, the neighbor info for the target AP MLD may be received/fetched in advance by the serving AP MLD or received/fetched from a controller. The buffer size 304 may indicate the maximum buffer size that the target AP MLD may support for block acknowledgement. The serving AP MLD may compare the buffer size 304 with a buffer size 306 that the serving AP MLD implements or uses to support or honor a BA agreement 308 between the serving AP MLD and a non-AP MLD. If the buffer size 304 is smaller than the buffer size 306, then the serving AP MLD may determine that the target AP MLD cannot support or honor the BA agreement 308.

During the roaming procedure for a non-AP MLD to roam to the target AP MLD, the serving AP MLD after receiving a roaming request (e.g., a roaming preparation request) for roaming to the target AP MLD and knowing that the target AP MLD supports a smaller BA buffer size 304, adjusts the BA agreement 308 to use the buffer size 304 supported or implemented by the target AP MLD. For example, if the buffer size 304 is smaller than the buffer size 306, the serving AP MLD may reduce the buffer size 306 in the BA agreement 308 to the buffer size 304. By adjusting the BA agreement 308, the serving AP MLD changes the BA agreement 308 such that the target AP MLD may support or honor the BA agreement 308. The serving AP MLD then transfers or communicates the adjusted BA agreement 308 to the target AP MLD. The serving AP MLD may adjust the buffer size for one or more BA agreements established between the non-AP MLD and the serving AP MLD.

The serving AP MLD also generates a message 310 (e.g., a roaming response or a roaming preparation response) that includes the adjusted BA agreement 308. For example, the message 310 may indicate the reduced buffer size 304. The serving AP MLD then communicates the message 310 to the non-AP MLD to inform the non-AP MLD of the adjusted BA agreement 308. The message 310 may include adjusted buffer size for one or more BA agreements. The non-AP MLD may then use the adjusted BA agreement 308 after roaming to the target AP MLD.

FIG. 3B illustrates an example message 310 in the system 100 of FIG. 1A. The message 310 may be a roaming response (e.g., a roaming preparation response) that uses a bitmap to indicate the parameters for BA agreements that were adjusted or updated. The message 310 may also include the updated parameters.

A current or serving AP MLD may generate and communicate the message 310 (e.g., a roaming response or a roaming preparation response) to a non-AP MLD to report the updated BA agreement so that the non-AP MLD is informed of the parameters of the updated BA agreement. As seen in FIG. 3B, the message 310 includes a TID bitmap 322 for DL block acknowledgement revised (or updated) parameters and a TID bitmap 324 for UL block acknowledgement revised parameters. The bitmap 322 may include bits that indicate the set of TIDs for which DL block acknowledgement agreement parameters (e.g., buffer size used by the non-AP MLD) are updated, and the bitmap 324 may include bits that indicate the set of TIDs for which UL block acknowledgement agreement parameters (e.g., buffer size used by the target AP MLD) are updated.

The message 310 may also include the updated block acknowledgement agreement parameters for the TIDs indicated in the bitmaps 322 and 324. For example, the message 310 may include a DL block acknowledgement parameters per TID list 326 and a UL block acknowledgement parameters per TID list 328. The DL block acknowledgement parameters per TID list 326 may include multiple block acknowledgement parameter sets 330 and 332, each providing updated DL BA parameters for a specific TID, and the UL block acknowledgement revised parameters per TID list 328 may include multiple block acknowledgement parameter sets 334 and 336, each providing updated UL BA parameters for a specific TID. In this manner, the message 310 signals to the non-AP MLD the block acknowledgement agreement parameters that were adjusted for DL or UL BA agreements. The non-AP MLD accepts and uses these updated BA parameters for data exchange with the target AP MLD.

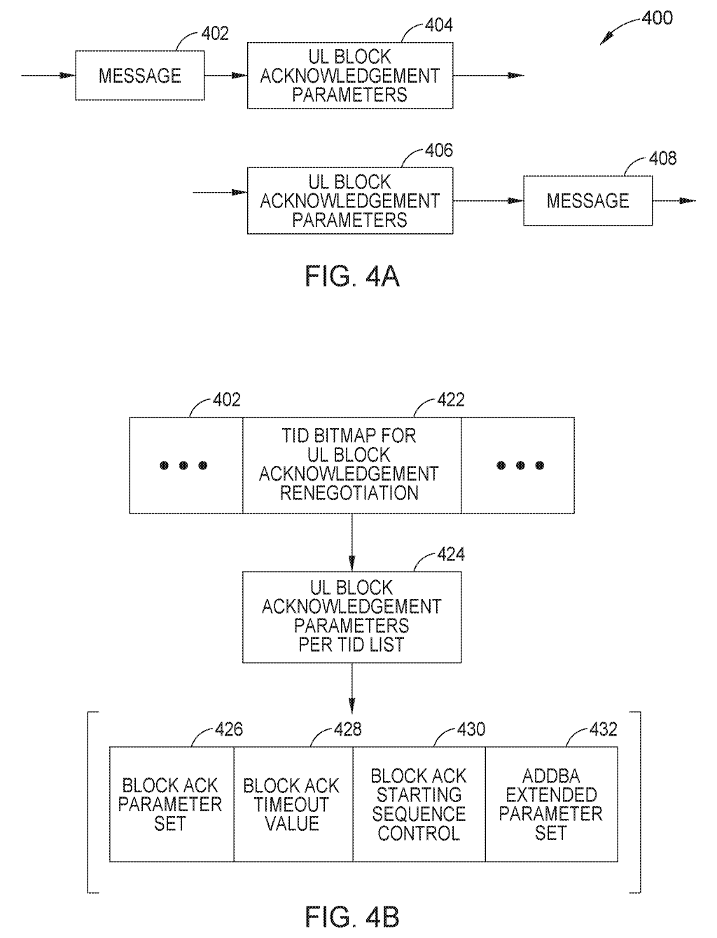

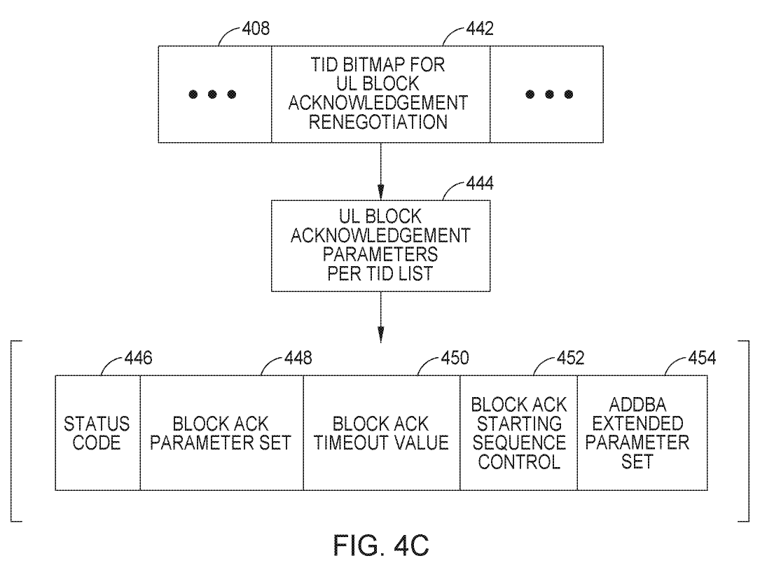

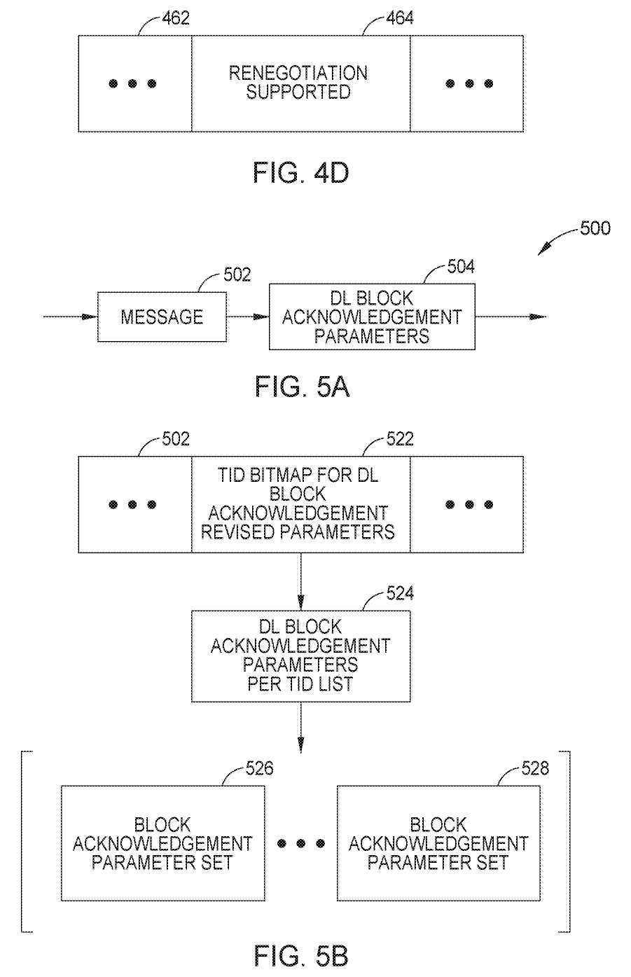

FIG. 4A illustrates an example operation 400 performed by the system 100 of FIG. 1A. Generally, a current or serving AP MLD (e.g., the AP MLD 104A shown in FIG. 1A) performs the operation 400. By performing the operation 400, the serving AP MLD renegotiates a BA agreement (e.g., an UL BA agreement).

The serving AP MLD begins by receiving a message 402 from a non-AP MLD that indicates UL BA parameters 404 for renegotiation with a target AP MLD. For example, the non-AP MLD may determine that the target AP MLD selected for seamless roaming or SMD roaming supports or implements different BA agreement parameters (e.g., a higher or lower buffer size than supported by the serving AP MLD) from a neighbor report or a reduced neighbor report (RNR) received in a basic service set (BSS) transition management (BTM) request, a neighbor report response, a probe response, or a (re)association response, etc. The non-AP MLD may generate the message 402 (e.g., a roaming request or a roaming preparation request) to indicate renegotiation (or negotiation) of UL BA parameters 404 for the target AP MLD, different from UL BA parameters implemented by the serving AP MLD (e.g., indicating that the UL BA parameters should be renegotiated/negotiated for the target AP MLD). The BA agreements negotiation may involve negotiating BA parameters for TIDs for which the non-AP MLD does not have BA agreements setup with the serving AP MLD. The non-AP MLD may renegotiate (or negotiate) the UL BA agreement parameters 404 with the target AP MLD by communicating the message 402 to the serving AP MLD. The serving AP MLD may then communicate the UL BA parameters 404 (along with requested values) to the target AP MLD to indicate that UL block acknowledgement parameters 404 is being renegotiated with the target AP MLD.

The target AP MLD may determine whether the target AP MLD may support or implement the requested values of the UL BA parameters 404. If a value for a UL BA parameter 404 is accepted, the target AP MLD may use the value for the UL BA parameter 404. If a value for a UL BA parameter 404 is not accepted, the target AP MLD may propose another value for the UL BA parameter 404. The target AP MLD may communicate the accepted or proposed values for the UL BA parameters 404 (shown as UL BA parameters 406) to the serving AP MLD. The serving AP MLD may then communicate the accepted or proposed values for the UL BA parameters 406 to the non-AP MLD in a message 408 (e.g., a roaming response or a roaming preparation response).

The non-AP MLD receives the UL BA parameters 406 in the message 408 from the serving AP MLD. The UL BA parameters 406 in the message 408 may be accompanied by status codes that indicate whether certain UL BA parameters 406 were accepted (e.g., successfully renegotiated), rejected, or include alternate proposed values. In some instances, if the renegotiation for an UL BA parameter fails, the non-AP MLD may keep the previous value for the UL BA parameter and transfer the previous value to the target AP MLD (with possible adjustment for buffer size if the target AP MLD supports a smaller buffer size).

In some instances, the non-AP MLD may renegotiate the UL BA parameters 404 for other reasons (e.g., to increase buffer size because the target AP MLD supports a larger buffer size, to set or reset a starting sequence number/starting sequence control of the block acknowledgement window to a certain value, etc.). The non-AP MLD may perform UL BA agreement renegotiation with the target AP MLD. The non-AP MLD may also perform UL BA agreements renegotiation when the target AP MLD supports a smaller buffer size. The non-AP MLD may perform UL BA agreements renegotiation with the target AP MLD for one or more TIDs for which BA agreement is already setup with the serving AP MLD. In some embodiments, the non-AP MLD may perform UL BA agreements negotiation with the target AP MLD for one or more TIDs for which no UL BA agreement is setup with the serving AP MLD (e.g., negotiate a new UL BA agreement with the target AP MLD). The UL BA parameters for BA renegotiation/negotiation may be provided by the non-AP MLD in the roaming request as part of an element/subelement, etc. The UL BA parameters provided for BA renegotiation/negotiation in the roaming request may include Block Ack Parameters Set, Block Ack Timeout Value, a BA starting sequence control and/or ADDBA Extended Parameter Set as further described below.

In some embodiments, the non-AP MLD adjusts or changes UL BA agreements to address instances when the target AP MLD uses a different buffer size, instead of performing UL BA agreements renegotiation.

FIG. 4B illustrates an example message 402 in the system 100 of FIG. 1A. Generally, a non-AP MLD (e.g., the non-AP MLD 106 shown in FIG. 1A) may communicate the message 402 (e.g., a roaming request or a roaming preparation request) to a current or serving AP MLD (e.g., the AP MLD 104A shown in FIG. 1A) to indicate UL BA parameters 406 for renegotiation.

As seen in FIG. 4B, the message 402 includes a TID bitmap 422 for UL BA renegotiation or negotiation. The bitmap 422 may include bits that indicate the TIDs for which UL BA agreements are being renegotiated. Additionally, the message 402 may include an UL BA parameters per TID list 424 that indicates the UL BA parameters for one or more TIDs that are being renegotiated or negotiated with the target AP MLD. As an example, for a particular TID, the message 402 may identify one or more of a block ack (block acknowledgement) parameters set 426 (e.g., including the TID and the buffer size), a block ack timeout value 428, and a block ack starting sequence control 430, and/or an ADDBA extended parameter set 432 that are being renegotiated. The non-AP MLD may communicate the message 402 to the serving AP MLD, and the serving AP MLD may communicate portions of the message 402 (e.g., the block ack parameter set 426, the block ack timeout value 428, the block ack starting sequence control 430) to the target AP MLD for renegotiation or negotiation. In some instances, the block ack starting sequence control 430 is not renegotiated and is not included in the message 402.

FIG. 4C illustrates an example message 408 in the system 100 of FIG. 1A. Generally, a current or serving AP MLD (e.g., the AP MLD 104A shown in FIG. 1A) may communicate the message 408 (e.g., a roaming response or a roaming preparation response) to a non-AP MLD (e.g., the non-AP MLD 106 shown in FIG. 1A) to indicate the status or results of renegotiating or negotiating UL BA agreements parameters with another AP MLD.

As seen in FIG. 4C, the message 408 includes a TID bitmap 442 for UL BA renegotiation. The TID bitmap 442 may include bits that indicate the set of TIDs for which UL BA agreements are being renegotiated or negotiated. Additionally, the message 408 may include an UL BA parameters per TID list 444 that indicates the UL BA parameters for one or more TIDs for which BA parameters are being renegotiated/negotiated. The UL BA parameters included in 444 for each TID may further indicate, per TID, a status code 446 for the renegotiation (e.g., indicating whether the renegotiation/negotiation was successful (accepted), rejected, or had new values proposed), a block ack parameter set 448, a block ack timeout value 450, or a block ack starting sequence control 452, and/or an ADDBA extended parameter set 454 that were renegotiated, along with their renegotiated values. The serving AP MLD may communicate the message 408 to the non-AP MLD to indicate the UL BA parameters that were renegotiated/ negotiated and their negotiated values.

FIG. 4D illustrates an example message 462 in the system 100 of FIG. 1A. Generally, an AP MLD (e.g., the AP MLD 104A shown in FIG. 1A) broadcasts the message 462 to advertise whether the AP MLD supports BA agreement renegotiation or negotiation during SMD roaming or seamless roaming. As seen in FIG. 4D, the message 462 may include a field or element 464 that indicates whether the AP MLD supports BA agreement renegotiation or negotiation. For example, the message 462 may include an SMD element that indicates whether the AP MLD supports BA agreement renegotiation or negotiation during roaming. In some instances, a non-AP MLD may request to perform BA agreement renegotiation or negotiation only if the AP MLD indicates that the AP MLD supports BA agreement renegotiation/negotiation.

FIG. 5A illustrates an example operation 500 performed by the system 100 of FIG. 1A. Generally, a current or serving AP MLD (e.g., the AP MLD 104A shown in FIG. 1A) performs the operation 500. By performing the operation 500, the serving AP MLD indicates DL BA parameters that have been updated by a non-AP MLD (e.g., the non-AP MLD 106 shown in FIG. 1A).

The serving AP MLD begins by receiving a message 502 (e.g., a roaming request or a roaming preparation request) from the non-AP MLD. The non-AP MLD may have determined that a target AP MLD uses a smaller buffer size than the serving AP MLD. As a result, the non-AP MLD may determine that certain DL BA parameters 504 should be adjusted so that the target AP MLD may support or honor the BA agreement. The non-AP MLD signals the updated DL BA parameters 504 in the message 502 to the serving AP MLD. The serving AP MLD may send the DL BA parameters 504 to the target AP MLD as part of roaming preparation. In this manner, the target AP MLD may be informed of the updated or adjusted DL BA parameters 504 from the non-AP MLD.

FIG. 5B illustrates an example message 502 in the system 100 of FIG. 1A. Generally, the non-AP MLD may communicate the message 502 to the serving AP MLD to indicate the DL BA agreement parameters that the non-AP MLD updated after determining that the target AP MLD cannot support or honor the BA agreement between the non-AP MLD and the serving AP MLD.

As seen in FIG. 5B, the message 502 includes a TID bitmap 522 indicating a set of TIDs for which DL BA parameters are being revised. The TID bitmap 522 may include bits that indicate the TIDs for which DL BA agreements are being revised. Additionally, the message 502 may include a DL BA parameters per TID list 524 that indicates the DL BA parameters (e.g., buffer sizes) that were adjusted by the non-AP MLD for one or more TIDs. For example, the message 502 may include BA parameters sets 526 and 528 that indicate BA parameters that were adjusted or updated by the non-AP MLD for specific TIDs (the corresponding TID value may be indicated as part of the BA parameter set 526 and 528).

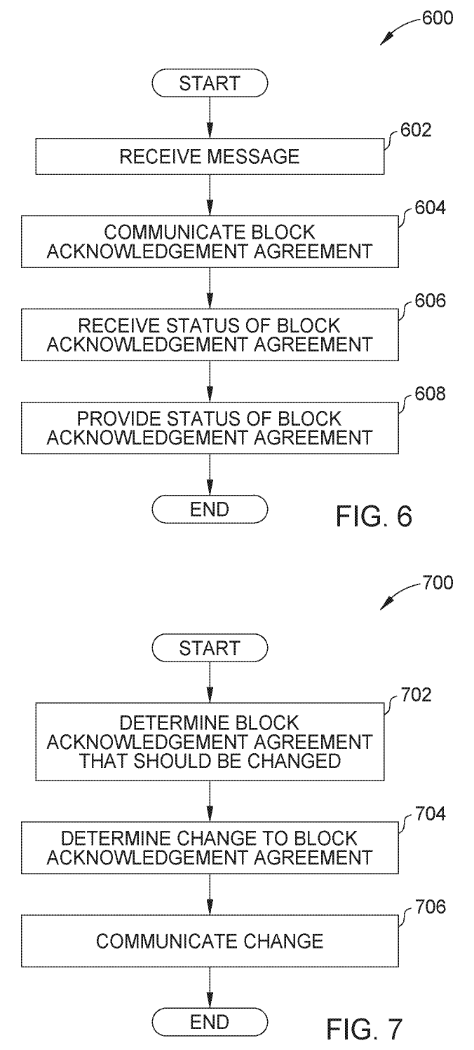

FIG. 6 is a flowchart of an example method 600 performed by the system 100 of FIG. 1A. In certain embodiments, a current or serving AP MLD (e.g., the AP MLD 104A shown in FIG. 1) performs the method 600. By performing the method 600, the serving AP MLD indicates to a target AP MLD a block acknowledgement agreement that should be adjusted or renegotiated.

At 602, the serving AP MLD receives a message. The message may be a roaming request from a non-AP MLD. The message may indicate one or more BA agreements that should be maintained or preserved when the non-AP MLD roams from the serving AP MLD to the target AP MLD. The message may also indicate one or more BA agreements that should be adjusted or renegotiated when the non-AP MLD roams from the serving AP MLD to the target AP MLD. Further, the message may also indicate one or more BA agreements that should be renegotiated or negotiated with the target AP MLD. For example, the non-AP MLD may have determined that the target AP MLD implements or uses a different buffer size than the serving AP MLD. In response, the non-AP MLD may determine that the buffer size of some of the BA agreements should be reduced before the non-AP MLD roams to the target AP MLD. The non-AP MLD may communicate the message to the serving AP MLD to signal that the BA agreements should be adjusted or changed.

At 604, the serving AP MLD may communicate the one or more BA agreements that should be maintained or preserved to the target AP MLD. The serving AP MLD may refrain from communicating to the target AP MLD the one or more BA agreements that should be adjusted or renegotiated. In this manner, the serving AP MLD signals to the target AP MLD the BA agreements that should be maintained or preserved during roaming and the BA agreements that should be adjusted or changed during roaming. For BA agreements that are being adjusted or renegotiated/negotiated, the target AP MLD may indicate a status for the BA agreements to the serving AP MLD at step 606. At 608, the serving AP MLD then provides the status indicating whether adjusted BA agreement parameters or the parameters for BA agreement renegotiation or negotiation are accepted by the target AP MLD and provides accepted BA parameters in a roaming response message to the non-AP MLD.

FIG. 7 is a flowchart of an example method 700 performed by the system 100 of FIG. 1A. In certain embodiments, a current or serving AP MLD (e.g., the AP MLD 104A shown in FIG. 1) performs the method 700. By performing the method 700, the serving AP MLD indicates to a target AP MLD a BA agreement that should be adjusted or renegotiated.

At 702, the serving AP MLD determines that a BA agreement with a non-AP MLD should be changed when the non-AP MLD roams from the serving AP MLD to the target AP MLD. For example, the serving AP MLD may determine that the target AP MLD uses a different buffer size than the serving AP MLD. In response, the serving AP MLD may determine that the BA agreement with the non-AP MLD should be adjusted or changed before the non-AP MLD roams to the target AP MLD.

At 704, the serving AP MLD determines a change to the BA agreement. For example, the serving AP MLD may adjust or change the BA agreement to reduce the buffer size.

At 706, the serving AP MLD communicates the change to the target AP MLD. For example, the serving AP MLD may communicate the adjusted or changed BA agreement to the target AP MLD. The serving AP MLD may also communicate the adjusted or changed BA agreement to the non-AP MLD. In this manner, both the non-AP MLD and the target AP MLD are aware of the adjusted or changed BA agreement.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A first access point multi-link device (AP MLD) comprising:
one or more memories; and
one or more processors communicatively coupled to the one or more memories, the one or more processors configured to, individually or collectively, perform an operation comprising:
receiving a message indicating that (i) a first block acknowledgement (BA) agreement with a non-access point multi-link device (non-AP MLD) should be maintained when the non-AP MLD roams from the first AP MLD to a second AP MLD and (ii) a second BA agreement with the non-AP MLD should be changed when the non-AP MLD roams from the first AP MLD to the second AP MLD; and
based on the message, communicating the first BA agreement to the second AP MLD and refraining from communicating the second BA agreement to the second AP MLD.

2. The first AP MLD of claim 1, wherein the message indicates at least one traffic identifier (TID) for which the second BA agreement should be changed, and wherein refraining from communicating the second BA agreement to the second AP MLD is limited to the at least one TID.

3. The first AP MLD of claim 2, wherein the message comprises a bitmap, and wherein the bitmap indicates the at least one TID.

4. The first AP MLD of claim 1, wherein the first BA agreement comprises a buffer size for block acknowledgements and a timeout value.

5. A first access point multi-link device (AP MLD) comprising:
one or more memories; and
one or more processors communicatively coupled to the one or more memories, the one or more processors configured to, individually or collectively, perform an operation comprising:
determining that a block acknowledgement (BA) agreement with a non-access point multi-link device (non-AP MLD) should be changed when the non-AP MLD roams from the first AP MLD to a second AP MLD;
determining a change to the BA agreement; and
communicating the change to the second AP MLD.

6. The first AP MLD of claim 5, wherein determining that the BA agreement should be changed comprises determining that the second AP MLD uses a different buffer size for block acknowledgements than a buffer size indicated by the BA agreement, wherein the operation further comprises changing the buffer size for block acknowledgements indicated by the BA agreement to the buffer size used by the second AP MLD to produce a changed BA agreement, and wherein communicating the change to the second AP MLD comprises communicating the changed BA agreement to the second AP MLD.

7. The first AP MLD of claim 6, wherein the operation further comprises communicating the changed BA agreement to the non-AP MLD.

8. The first AP MLD of claim 5, wherein determining that the BA agreement should be changed comprises receiving, from the non-AP MLD, a message indicating that the second AP MLD uses a different buffer size for block acknowledgements than a buffer size indicated by the BA agreement, and wherein communicating the change to the second AP MLD comprises communicating the different buffer size to the second AP MLD.

9. The first AP MLD of claim 5, wherein determining that the BA agreement should be changed comprises receiving, from the non-AP MLD, a first message to renegotiate or negotiate the BA agreement, and wherein communicating the change to the second AP MLD comprises renegotiating or negotiating the BA agreement with the second AP MLD.

10. The first AP MLD of claim 9, wherein the first message indicates that the non-AP MLD determined to renegotiate or negotiate BA agreements for one or more traffic identifiers (TIDs) with the second AP MLD based on the second AP MLD supporting a different buffer size for block acknowledgements.

11. The first AP MLD of claim 10, wherein the different buffer size for block acknowledgements at the second AP MLD is higher or lower than a buffer size supported for block acknowledgements by the first AP MLD.

12. The first AP MLD of claim 9, wherein:
renegotiation of BA agreements comprises renegotiating BA agreements with the second AP MLD for a TID for which a BA agreement is setup with the first AP MLD; and
negotiation of BA agreements comprises negotiating BA agreements with the second AP MLD for a TID for which no BA agreement is setup with the first AP MLD.

13. The first AP MLD of claim 9, wherein the operation further comprises receiving a response from the second AP MLD indicating which of the BA agreements were successfully renegotiated or negotiated.

14. The first AP MLD of claim 9, wherein the operation further comprises sending a response to the non-AP MLD to indicate which of the BA agreements were successfully renegotiated or negotiated with the second AP MLD.

15. The first AP MLD of claim 9, wherein the first message indicates renegotiation or negotiation of at least one of a buffer size for block acknowledgements used by the second AP MLD, a BA timeout value, or a BA starting sequence number.

16. The first AP MLD of claim 9, wherein the operation further comprises communicating, to the non-AP MLD, a second message indicating that the first AP MLD supports renegotiation of the BA agreement during roaming, and wherein the first message is received in response to the second message.

17. An apparatus comprising:
one or more memories; and
one or more processors communicatively coupled to the one or more memories, the one or more processors configured to, individually or collectively, perform an operation comprising:
determining that a block acknowledgement (BA) agreement with a serving access point multi-link device (AP MLD) should be changed when roaming from the serving AP MLD to a target AP MLD;
determining a change to the BA agreement; and
renegotiating or negotiating the BA agreement with the target AP MLD prior to roaming to the target AP MLD.

18. The apparatus of claim 17, wherein renegotiating or negotiating the BA agreement with the target AP MLD comprises communicating a message to the serving AP MLD indicating that the BA agreement should be renegotiated or negotiated.

19. The apparatus of claim 17, wherein the operation further comprises receiving, from the serving AP MLD, a message indicating a status of renegotiating or negotiating the BA agreement with the target AP MLD.

20. The apparatus of claim 17, wherein determining that the BA agreement should be changed when roaming from the serving AP MLD to the target AP MLD is based on the target AP MLD using a different buffer size for block acknowledgements than the serving AP MLD.
